(19) United States
(12) Patent Application Publication
(10) Pub. No.: US 2022/0065639 A1
(43) Pub. Date: Mar. 3, 2022

(54) ROAD SEGMENT RANKING

(71) Applicant: INRIX, Inc., Kirkland, WA (US)

(72) Inventors: Stephen Henry MISTELE, Kirkland, WA (US); Kevin Tom ROONEY, Monte Sereno, CA (US); Aidan James John MACKEY, Coto de Caza, CA (US); Nicholas Anders TALLIS, Darien, CT (US); Bryn John MILLS, Wolverhampton (GB); Jeffrey Adam SUMMERSON, Duvall, WA (US)

(21) Appl. No.: 17/011,172

(22) Filed: Sep. 3, 2020

(51) Int. Cl. G01C 21/34; G01C 21/36

(52) U.S. Cl. CPC G01C 21/3461; G01C 21/3446; G01C 21/3617; G01C 21/3694; G01C 21/3676

(57) ABSTRACT

One or more techniques and/or systems are provided for road segment ranking. Incident data associated with a first road segment is evaluated to determine an incident trend for the first road segment. Factors for the first road segment are identified. A first danger rating is assigned to the first road segment based upon the incident trend and the factors. The first danger rating is displayed on a display of a device.

### BACKGROUND

Some roads and road segments of the roads may be more dangerous than other roads and road segments. For example, a first road segment may be more dangerous than a second road segment due to various factors, such as tighter turns in the road, dangerous slowdowns, construction, etc. These levels of danger can change over time, such as due to changes in weather, construction, glare occurring only in the evening, a fallen tree, pothole being repaired, etc. which may make a road segment more dangerous or safer. There are a variety of factors that can be the cause of accidents along road segments, such as glare from the sun, potholes, high speed limits, inclement weather, road geometry with sharp turns or sudden stops, etc.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for road segment ranking are provided. When an incident, such as an accident, occurs along a road segment, incident data may be generated. The incident data may specify various information regarding the incident, such as a time of day, a severity of the incident, weather conditions, a location of the incident, a vehicle type involved in the incident, etc. Accordingly, the incident data may be acquired and evaluated to assign danger ratings to road segments. For example, incident data associated with a first road segment may be acquired, such as by being retrieved by a road assessment component hosted by a computing device (e.g., the road assessment component may be hosted by a server, a computer, a virtual machine hosted within a cloud computing environment, etc.) from a data source hosted by a remote device or service. The incident data may be evaluated to determine an incident trend for the first road segment. For example, the incident data may indicate that numerous accidents, such as an abnormally large number of accidents, occurred between 4:00 pm and 6:30 pm over the past 3 months. Accordingly, the road assessment component may determine an incident trend for the first road segment corresponding to a high accident trend between 4:00 pm and 6:30 pm along the first road segment.

The road assessment component may identify factors associated with the first road segment. The factors may be specified within data obtained by the road assessment component from various data sources and services and/or inferred by the road assessment component from the data. The factors may correspond to differences between safe road segments and dangerous road segments. The factors may correspond to historical accident data, road volume data (e.g., an amount of vehicles traveling along the first road segment over a period of time), tight/sharp turns, potholes, a time of day of an incident, high traffic speeds with dangerous mergers, vehicle types of vehicles that typically travel the first road segment (e.g., 95% of traffic is trucks), a date of an incident (e.g., how long ago was the incident), road geometry (e.g., is the road curvy or straight), a length of the first road segment, historical construction improvement for the first road segment, demographics of drivers along the first road segment, demographics of residents that live near or along the first road segment, real time events (e.g., current construction, accidents, large events, etc.), dangerous slowdowns, speed limits, autonomous vehicle data (e.g., extrapolated data indicative of causes of accidents), insurance reports, animal crossing locations, presence of pedestrians or bikes, weather, imagery (e.g., street view imagery depicting a tree that is obstructing a stop sign) and/or a wide variety of other factors.

The road assessment component may assign a first danger rating to the first road segment based upon the incident data and the factors. In an example, the first danger rating may correspond to a range of values, such as from 1 to 5 where 1 is the least dangerous and 5 is the most dangerous. It may be appreciated that any range of values (e.g., discrete values, continuous values, values from 0 to 10, values from 1 to 20, etc.) may be utilize for danger ratings. A relatively more dangerous danger rating may be assigned based upon the incident data indicating more frequent and/or serve accidents and the factors indicating more dangerous causes of the accidents (e.g., a curvy road with a dangerous slowdown and a high speed dangerous merge). The first danger rating may be updated over time as new incident data is acquired and as factors change. The first danger rating may be provided through a display of device, such as a vehicle navigation unit, a mobile device, etc. For example, danger ratings for road segments of suggested routes to a destination location to which a driver is traveling may be provided so that the driver can make a selection based upon the danger/safety of traveling such routes.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of road segment ranking.

FIG. 2 is a component block diagram illustrating an exemplary system for road segment ranking.

FIG. 3 is a component block diagram illustrating an exemplary system for road segment ranking, where a user interface is displayed.

FIG. 4 is a component block diagram illustrating an exemplary system for road segment ranking, where road segments of routes are ranked and displayed.

FIG. 5 is an illustration of an exemplary computing device-readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

One or more computing devices and/or techniques for road segment ranking are provided. Many devices may provide routing functionality to users. For example, a user may input a destination location into a user interface of a device, such as a mobile device or vehicle navigation unit. The user may be presented with a set of suggested routes to the destination location. The user interface may display travel times for each of the suggested routes. Once the user selects a route, the route is displayed through the user interface. Accidents, construction, and sections of slow traffic may be displayed along the route. In general, users usually select a shortest route to the destination location. Unfortunately, the users are not provided with information regarding how dangerous or safe are each of the routes and/or road segments making up the routes. At best, the user may be provided with slow traffic indicators, construction indicators, and/or accident indicators along a selected route. Thus, users are unaware of how dangerous or safe are the roads and road segments, and why the roads and road segments are dangerous or safe such as what is causing accidents. Because the users are not provided with adequate information relating to road safety, the users may be unaware that they are selecting a route, such as a faster route, that is dangerous and has an increased likelihood of the user having an accident along the route.

Accordingly, as provided herein, road segments are ranked with danger ratings indicative of how dangerous each of the road segments are to travel. Danger ratings can be determined based upon incident data and factors indicative of how safe or dangerous are each road segment. The danger ratings can be determined and/or updated in real-time as new incident data and/or changes in factors become available. The danger ratings may be personalized for particular drivers and vehicles being driven by the drivers. The danger ratings may be provided to the drivers, such as display through a user interface of a devices of a driver so that the driver can understand what roads are dangerous or safe and reasons (the factors) why the road segments are deemed to be dangerous or safe. This allows the driver to select a route based upon how dangerous or safe are road segments of the route. With this information, the driver can make a more informed decision regarding how to take safer routes in order to reduce the likelihood of accidents. In this way, new types of information (danger ratings) are determined and provided through devices to drivers so that the drivers can make more informed decisions when using the devices to obtain routes to destinations, such as with the ability to select safer routes and avoid dangerous routes. Additionally, operation of the device to route the user is improved because the device can now take into account how dangerous or safe routes are when identifying and recommending what routes to suggest and use for routing drivers to destination locations.

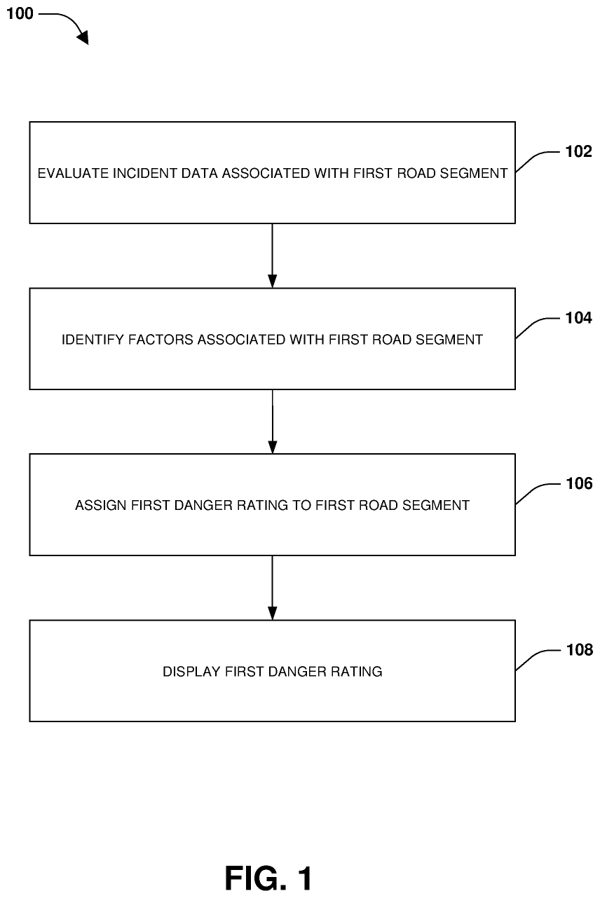

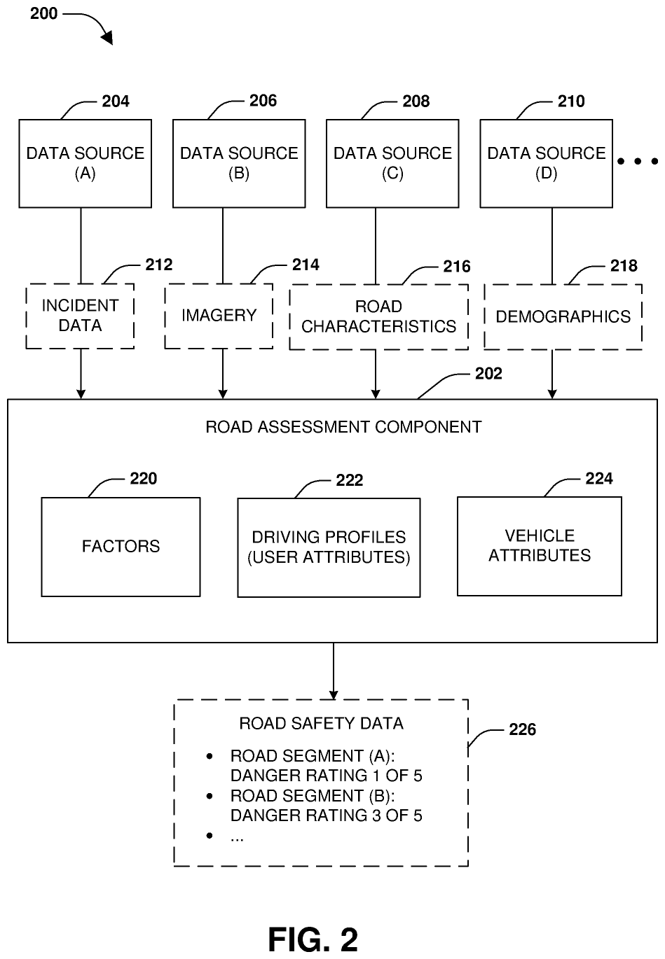

An embodiment of road segment ranking is illustrated by an exemplary method 100 of FIG. 1, and is described in conjunction with respect to system 200 of FIG. 2. The system 200 may comprise a road assessment component 202 comprising software, hardware, and/or a combination thereof. In an embodiment, the road assessment component 202 is hosted by a computing device. The computing device may comprise a mobile device of a driver, a vehicle navigation unit of a vehicle, a server, a virtual machine hosted within a cloud computing environment, etc. The road assessment component 202 may be comprised of software and/or hardware of the computing device. The road assessment component 202 may utilize communication functionality of the computing device to access data sources, such as remote computing devices accessible to the computing device over a network. For example, the road assessment component 202 may connect to a data source (A) 204, a data source (B) 206, a data source (C) 208, a data source (D) 210, and/or other data sources over the network.

The road assessment component 202 my retrieve various types of data from each data source for assigning danger ratings to road segments. The danger ratings are used for indicating and ranking how dangerous or safe is each road segment. For example, the road assessment component 202 may retrieve incident data 212 from the data source (A) 204 (e.g., data from a traffic agency database, a police report database, an insurance claim database, or other data sources or services). The incident data 212 may describe incidents that occur along road segments, such as accidents (e.g., a date and time of day of an accident, a severity of the accident, a cause of the accident, weather conditions, and/or other circumstances surrounding the accident). In another example, the road assessment component 202 may retrieve imagery 214 from the data source (B) 206 (e.g., data from a street view service that provides street side imagery and satellite imagery of roads). The imagery 214 may depict various aspects of road segments that may be extracted/identified using machine learning and image processing techniques as factors indicative of how dangerous or safe are the road segments (e.g., whether a fallen tree is blocking an intersection, whether a bush is blocking the view at an intersection, a depiction of numerous pedestrians crossing a road segment, a pothole, orange construction barrels, a presence of bikes, a presence of a bike lane, an obstructed stop sign, a blind curve, a depiction of a potential distraction on a road, etc.).

In another example, the road assessment component 202 may retrieve road characteristics 216 from the data source (C) 208 (e.g., data from a road database of roads, maps, etc.). The road characteristics 216 may specify lengths of road segments, numbers of lanes of road segments, whether a road segment is a one-way road or a two-way road, curvatures of road segments, speed limits of road segments, whether a road segment has a bike lane, road geometry, and/or other characteristics of road segments. In another example, the road assessment component 202 may retrieve demographic data 218 from the data source (D) 210 (e.g., data from a social network service, data from user profiles, data from a demographic repository, census data, data extract from images, a residential data repository, data from an address or white pages service, etc.). The demographic data 218 may be indicative of age, occupation, gender, home address, driving history, and/or other information of drivers and/or of residents living proximate to road segments (e.g., a nursing home may be located within a block of a road segment, thus residents near the road segment may be identified as being 80 years old or older; a road segment may be lined with college campus houses, thus residents near the road segment may be identified as being college age; a road segment may be lined with starter homes, thus residents near the road segment may be identified as young families, etc.). It may be appreciated that the road assessment component 202 may retrieve a wide variety of data from various data sources.

At 102, the road assessment component 202 evaluates the incident data 212 associated with road segments to determine incident trends for the road segments, such as an incident trend for a road segment (A), an incident trend for a road segment (B), etc. For example, the road assessment component 202 may evaluate the incident data 212 to identify a number of accidents along the road segment (A) during various timespans (e.g., accidents within the past week, accidents during a particular month, accidents within the past 6 months, etc.). The incident trend for the road segment (A) may correspond to the number of accidents along the road segment during one or more timespans. The incident trend may be indicative of how dangerous is the road segment (A), such as where the road segment (A) is more dangerous because there is an abnormally high number of accidents along the road segment (A). In an example, an incident trend may indicate an abnormally high number of accidents, and thus an assumption may be made that a combination of one or more factors is causing the accidents (e.g., a missing stop sign, an malfunctioning stop light, a dangerous merge, a sharp curve, glare from the sun, road geometry that is tough for trucks to navigate, inexperienced drivers or drunk drivers typically driving a road segment, etc.). Thus, the incident trends for the road segments and factors 220 associated with the road segments can be used to predict causes of the abnormally high number of accidents.

At 104, factors 220 associated with the road segments may be identified by the road assessment component 202. The factors 220 may be identified based upon an evaluation of the incident data 212 (e.g., a number of accidents per road segment), the imagery 214, the road characteristics 216, the demographics 218, vehicle attributes 244 of vehicles driving along the road segments or a vehicle of a driver requesting a route to a destination from the road assessment component 202, driving profiles 222 of the drivers of the vehicles and/or the driver requesting the route, and/or a wide variety of other data. In an example of identifying the factors 220, a factor may correspond to features extracted from the imagery 214 using image analysis such as machine learning functionality and image recognition functionality implemented by the road assessment component 202. For example, the features may correspond to an obstructed stop sign factor, a fallen tree factor, a presence of bikes factor (e.g., indicative of a potentially dangerous bike lane), a presence of pedestrians factor (e.g., indicative of a potentially dangerous sidewalk), a blind curve factor, a potential distraction factor, etc. These factors may correspond to features (e.g., an identification of the fallen tree within an image; an identification of a biker within an image; etc.) extracted from the imagery using machine learning functionality and image recognition functionality. These feature may also be identified from other sources than just the imagery 214.

In another example of identifying the factors 220, the road assessment component 202 may obtain and evaluate autonomous vehicle data in order to identify factors that may be indicative of whether the road segments are dangerous or safe. For example, the autonomous vehicle data may comprise speed measurements, imagery, sensor data, weather conditions, braking patterns, video, and/or a variety of other data that may be collected from sensors and computers within a vehicle, such as data collection proximity in time to an accident involving the vehicle. Such data may be indicative of factors that caused the accident, such as an image or video of a large pothole or steering patterns indicative of the vehicle turning along a sharp curve. In this way, the autonomous vehicle data may be processed to extrapolate causes of accidents, which can be used for predictive analysis as to whether a road segment is dangerous, how likely an accident is to occur along the road segment, etc.

In another example of identifying the factors 220, the road assessment component 202 may evaluate the road characteristics 216 to identify factors that may be indicative of whether the road segments are dangerous or safe. For example, the road characteristics 216 may be indicative of a tight turn factor, a speed limit factor (e.g., a high speed factor), a dangerous merge factor, a road volume factor (e.g., an volume of vehicles on a road segment over a particular timespan), a road class factor (e.g., one-way street, two-way street, a highway, a ramp, a city road, etc.), a road segment length factor, a road segment geometry factor (e.g., how curvy or straight is a road segment), an animal crossing location factor, a vehicle type factor (e.g., vehicle types of vehicles typically traveling a road segment), a historic construction improvement factor for a road segment (e.g., a last time a road segment was repaved to fix potholes or install safety features), and/or a variety of other factors relating to road segments.

In another example of identifying the factors 220, the road assessment component 202 may evaluate the incident data 212 to identify factors that may be indicative of whether the road segments are dangerous or safe. For example, the incident data 212 may be indicative of factors relating to a time of day when an accident occurred, a time since a last accident occurred along a road segment, a severity of the accident, a total number of accidents for a road segment, weather conditions during an accident along a road segment, direction of travel of a vehicle when an accident occurred (e.g., was the vehicle heading towards the sun, and thus glare was a causation factor of the accident), police report information (e.g., whether a crime was involved in an accident along a road segment), whether a dangerous slowdown occurred, an insurance report relating to causes of accidents along a road segment, and/or a variety of other factors relating to incidents along road segments.

In another example of identifying the factors 220, the road assessment component 202 may evaluate the demographic data 218 to identify factors that may be indicative of whether the road segments are dangerous or safe. For example, the demographic data 218 may be indicative of demographic information of drivers typically driving along a road segment and/or of residents living near the road segment, such as age, gender, occupation, and/or other demographic information that may be indicative of how safe or dangerous are the drivers along the road segment and/or of residents living within a proximity distance to the road segment. Such information may be used to construct the driving profiles 222 that are populated with user attributes (driver attributes) of the drivers and residents (e.g., age attributes, gender attributes, accident history attributes, income attributes, etc.).

This demographic data 218 may be used to construct the vehicle attributes 224 of vehicles that are driven by the drivers and/or owned by the residents. The vehicle attributes 224 may relate to what safety features a vehicle has or lacks, maintenance history of a vehicle, whether the vehicle has been in prior accidents, tire wear, make and model of a vehicle, age of a vehicle, features enabled on the vehicle (e.g., whether the vehicle has a lane departure feature enabled or disabled), etc. In this way, the road assessment component 202 can utilize the driving profiles 222 and the vehicle attributes 224 to generate danger ratings that are specific to a particular driver and vehicle (e.g., a road segment may be more dangerous for an older vehicle without a driving assist feature, a road segment may be more dangerous for young drivers, a road segment may be more dangerous for trucks, etc.).

In another example of identifying the factors 220, the road assessment component 202 may obtain and evaluate real-time data to identify factors that may be indicative of whether the road segments are dangerous or safe. The real-time data may be used by the road assessment component 202 so that the most up-to-date data and information can be utilized by the road assessment component 202 for assigning danger ratings for road segments, and for update the danger ratings in real-time. In an example, the real-time data may be indicative of factors relating to current weather conditions, current traffic reports, current incident reports, current construction, an occurrence of an event, etc.

At 106, danger ratings are assigned to the road segments by the road assessment component 202 based upon the incident trends, the factors 220, the driving profiles 222, and/or the vehicle attributes 224 to create road safety data 226. In an example, the road assessment component 202 may utilize machine learning functionality to process the incident trends and/or the factors 220 to determine danger ratings for road segments to indicate how safe or dangerous are the road segments (e.g., a danger rating scale of 1 to 5 or any other range of values may be used for danger ratings). In an example, the road assessment component 202 may utilize an algorithm that may take into account any number of factors that are available for outputting a danger rating for a road segment. For example, the algorithm may combine together (e.g., multiply together) certain factors, such as total accidents, average severity of the accidents, a road geometry factor, a demographic risk (e.g., how risky are typical drivers along the road segment and/or residents near the road segment), a personal user risk factor (e.g., how risky is a particular driver for which the road assessment component 202 is going to provide suggested routes to a destination location for the driver), a dangerous slowdown factor, a speed limit factor, a weather risk factor (e.g., is it currently snowing), a real-time risk factor (e.g., is there currently an large event causing dangerous congestion), an animal crossing factor, a pedestrian danger factor (e.g., are there many pedestrians typically along and/or crossing the road segment) a bike factor (e.g., is there a bike lane or bicyclists along the road segment), and/or other factors that may be combined together to obtain a first value. The larger the first value, the more dangerous the road segment. The road assessment component 202 may utilize the algorithm to divide the first value by a second value. The larger the second value, the less dangerous the road segment. The second value may be based upon the combination (e.g., multiplication) of various factors, such as a volume of traffic along the road segment, a number of days since a last accident, a construction improvement factor (e.g., how recently was the road segment repaved/repair, how recently was new traffic safety equipment installed for the road segment, etc.). Accordingly, the road assessment component 202 may utilize the algorithm to divide the first value by the second value to output a danger rating for the road segment. In this way, the road safety data 226 is generated by the road assessment component 202, such as where a danger rating of 1 out of 5 (e.g., where 1 is low danger) is assigned to the road segment (A), a danger rating of 3 out of 5 (e.g., where 3 is moderate danger) is assigned to the road segment (B), etc.

In an embodiment, the road safety data 226 may comprise a large amount of data because of the number of road segments that may be evaluated by the road assessment component 202, such as where the road assessment component 202 is determining danger ratings for a large number of routes spanning a long distance. Accordingly, the road assessment component 202 may reduce the road safety data as a reduced set of road safety data. The reduced set of road safety data may correspond to percentages of road segments along the set of routes that correspond to values of danger rates. For example, the reduced set of road safety data may specify that 5% of road segments along a route have a danger rating of 5, 25% of road segments along the route have a danger rating of 4, 25% of road segments along the route have a danger rating of 3, 40% of road segments along the route have a danger rating of 2, and 5% of road segments along the route have a danger rating of 1.

In an embodiment, the road assessment component 202 may evaluate the factors 220 and the incident data 212 to identify causation factors. The causation factors are factors that have a likelihood above a threshold of being a cause of incidents along the road segments. For example, if more than a certain percentage of incidents occurred in the evening along a road segment facing west (e.g., more than 82% of accidents occurred in the evening), then glare from the sun may be determined to be a causation factor that is helping cause accidents along the road segment. In another example, if more than a certain percentage of incidents occurred between 7:30 am and 8:30 am, then rush hour traffic may be determined to be a causation factor that is helping cause accidents along the road segment.

In an embodiment, the road assessment component 202 may lack a threshold amount (an adequate amount) of incident data for accurately assigning a danger rating to a road segment. Accordingly, the road assessment component 202 may compare factors of the road segment to factors of other road segments for which the road assessment component 202 was able to adequately assign danger ratings. If a threshold amount of factors of the road segment are similar to factors of another road segment already rated with a danger rating, then the danger rating is assign to the road segment. In this way, correlations of factors between road segments can be used to infer danger ratings for road segments for which there is a lack of incident data. Similarly, image analysis may be performed upon imagery of the road segment for which there is a lack of adequate incident data to identify factors that can be compared to factors extracted from imagery of the other road segments for which the road assessment component 202 was able to adequately assign danger ratings. If a threshold amount of the factors of the road segment extracted from the imagery of the road segment are similar to factors of another road segment already rated with a danger rating, then the danger rating is assign to the road segment.

In an embodiment, a factor for a road segment may change over time as a changed factor (e.g., construction may finish along a road segment, a fallen tree branch may be removed from the road segment, a pothole may be repaired, a stop sign be run over and destroyed, etc.). The change in the factor for the road segment may affect the safety of the road segment. Accordingly, changes in factors may be monitored (e.g., real-time monitoring of the data sources) so that danger ratings for road segments can be recomputed based upon the changes.

At 108, one or more danger ratings may be displayed on a display of device. In an embodiment, numerical values of danger ratings, colors associated with danger rates, visual indicators associated with danger ratings, and/or other information used to convey danger ratings and/or how dangerous or safe are road segments (e.g., a description as to why a road segment is deemed to be dangerous, such as causation factors that led to the determination that the road segment is dangerous; a predicted likelihood that an accident will occur along the road segment during a particular timeframe; etc.) may be displayed through a user interface. For example, a map of an area containing a plurality of road segments may be displayed through the user interface. Visual characteristic of the plurality of road segments may be modified based upon danger ratings of the plurality of road segments (e.g., a first color or thickness may be applied to a first road segment having a danger rating of 1, a second color or thickness may be applied to a second road segment having a danger rating of 2, a third color or thickness may be applied to a third road segment having a danger rating of 3, etc.). In another example, numerical values of danger rating for the plurality of road segments may be overlaid the road segments within the map. In another example, as a driver is approaching a road segment (e.g., a current location is within a threshold distance of the road segment while the drive is heading towards the road segment) having a danger rating exceeding a danger threshold, a warning about the road segment may be displayed. For example, the warning may comprise a message about why the road segment is dangerous, a suggestion of an alternate road segment to use instead, a predicted likelihood that an accident will occur along the road segment during a particular timeframe (e.g., a timeframe during which the driver will drive along the road segment), a suggestion regarding how to drive the road segment in a manner that would reduce the likelihood of an accident (e.g., a suggestion to turn on high beams, a suggestion to watch for a fallen tree, a notification that a stop sign is blocked by a bush, etc.), the danger rating, etc.

In an embodiment, the road assessment component 202 may be configured to assign danger ratings to planned road segments not yet built. For example, information corresponding to a planned road segment may be identified, such as road geometry of the planned road segment, demographics of residents located near the planned road segment, characteristics of a location at which the planned road segment is to be built (e.g., a city, in the country, nearby businesses, etc.), etc. Accordingly, the road assessment component 202 may evaluate the information in order to assign a danger rating to the planned road segment.

In an embodiment, the road assessment component 202 maintains the driving profiles 222 of drivers. A driving profile for a driver may be generated based upon one or more trips traveled by the driver. The driving profile may specify an age of the driver, a driving experience level of the driving, statistics regarding how the driver operates a vehicle (e.g., does the driver routinely brake hard, does the driving forget to use a turn signal, an average speed over the speed limit that the user usually drives, etc.), a gender of the driver, does the driver routinely use devices such as mobile phones while driving (a distracted driver), and/or a wide variety of other information about the driver. The driving profile may be utilized by the road assessment component 202 to personalize the calculating of danger ratings for this particular driver. That is, information within the driving profile may be used as factors for consideration by the algorithm used by the road assessment component 202 to calculate danger ratings. For example, a road segment with a high speed limit and sharp curves may be more dangerous for a truck driver than a car driver. If a driver does not yet have a driving profile, then trends of drivers may be identified across demographic profiles (e.g., trends identified within driving profiles for males age 16 to 20, trends identified within driving profiles for drivers that reside in a particular neighborhood, etc.) as trend data that can be used to pre-populate a driving profile for the driver. Accordingly, the driving profile for the driver is pre-populated with a portion of the trend data corresponding to demographic profile information of the driver (e.g., if the driver is a male age 17, then the driving profile may be prepopulated with the trends identified within driving profiles for males age 16 to 20).

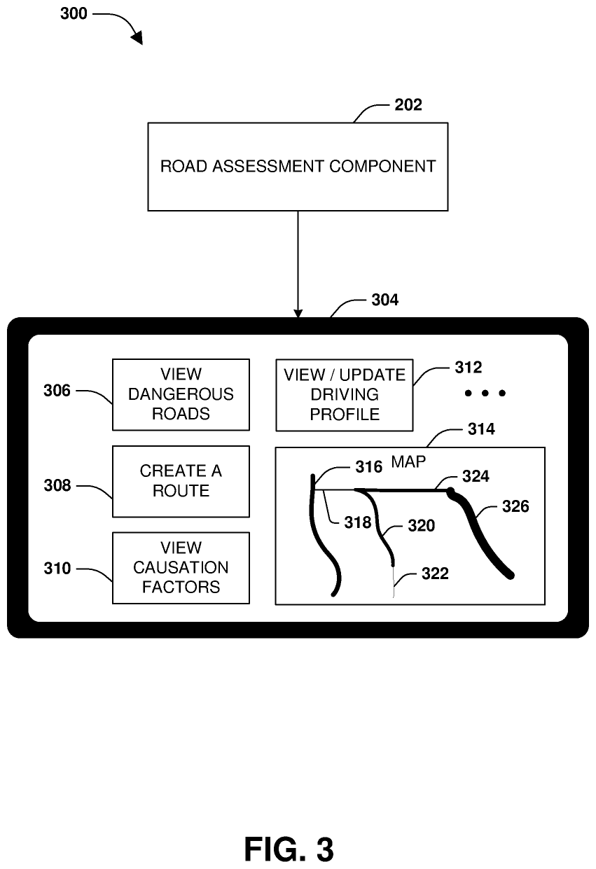

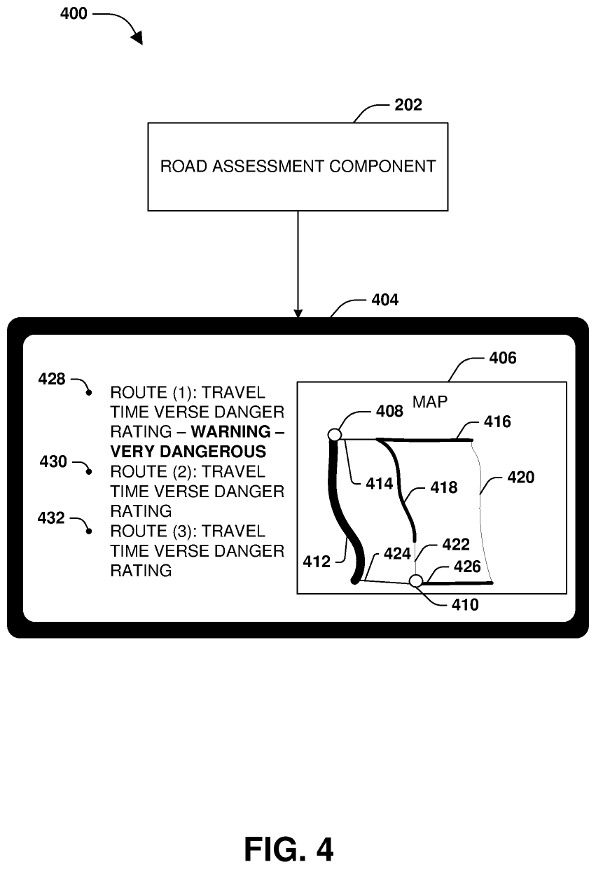

In an embodiment, the danger ratings within the road safety data 226 may be utilized by the road assessment component 202 for suggesting routes to a driver, which is further described in conjunction with system 300 of FIG. 3 and system 400 of FIG. 4. In an example, the driver may utilize a device 304 to access a user interface, such as a navigation user interface, executing on the device 304, as illustrated by FIG. 3. The device 304 may comprise a vehicle navigation unit, a mobile device such as a smart phone or smart watch, a wearable device, or other computing device. The road assessment component 202 may be hosted by the device 304 or may be hosted by a remote device that is connected to the device 304 over a network.

The device 304 may be currently located within a region, which is displayed on a map 314. The map 314 may be populated with road segments, such as a first road segment 316, a second road segment 318, a third road segment 320, a fourth road segment 322, a fifth road segment 324, and a sixth road segment 326. Visual characteristics of the road segments, such as thickness or color, may be modified based upon danger ratings of the road segments. For example, the sixth road segment 326 may have a danger rating of 9 out of 10, and thus a thickness of the sixth road segment 326 is much thicker than other road segments having smaller danger ratings such as the second road segment 318 having a danger rating of 1 out of 10.

The driver may utilizing the device 304 to input a command through a view dangerous roads user interface element 306 of the user interface to cause the road assessment component 202 to display road segments and danger ratings of road segments that have danger ratings above a danger threshold. The driver may utilize the device 304 to input a command through a create route user interface element 308 of the user interface to cause the road assessment component 202 to create and suggest routes to a destination location, along with displaying danger ratings for the routes and/or road segments of the routes. The driver may utilize the device 304 to input a command through a view causation factors user interface element 310 of the user interface to cause the road assessment component 202 to display causation factors for why a road segment is considered safe/dangerous, such as displaying text specifying that a road segment is dangerous at night due to a lack of street lighting and lots of sharp curves in the road segment. The driver may utilizing the device 304 to input a command through a view/update driving profile user interface element 212 of the user interface to cause the road assessment component 202 to display an interface through which the driver can view and modify a driving profile of the driver.

FIG. 4 illustrates a system 400 where the road assessment component 202 provides suggested routes through a user interface displayed on a device 404 being accessed by a driver. For example, the driver may input a request for suggested routes to a destination location 410. Accordingly, the road assessment component 202 may display a map 406 populated with the suggested routes from a starting location 408 to the destination location 410. The routes may be composed of road segments, such as first route comprising a first road segment 412 and a second road segment 424, a second route comprising a third road segment 414, a fourth road segment 418, and a fifth road segment 422, and a third route comprising the third road segment 414, a sixth road segment 416, a seventh road segment 420, and an eighth road segment 426. The road segments may be assigned danger ratings indicative of how safe/dangerous are the road segments, which may be assigned based upon factors of the road segments, incident data for the road segments, vehicle attributes of a vehicle being driven by the driver, driver attributes (user attributes) within a driving profile for the driver, demographic information, etc. The road assessment component 202 may display comparisons of travel times of the routes verse danger ratings for the routes, along with warnings of any particularly dangerous routes, such as a comparison and warning 428 for the first route, a comparison 430 for the second route, and a comparison 432 for the third route. In this way, the driver can take into consideration how danger are routes and/or road segments of the routes when selecting a particular route to utilize.

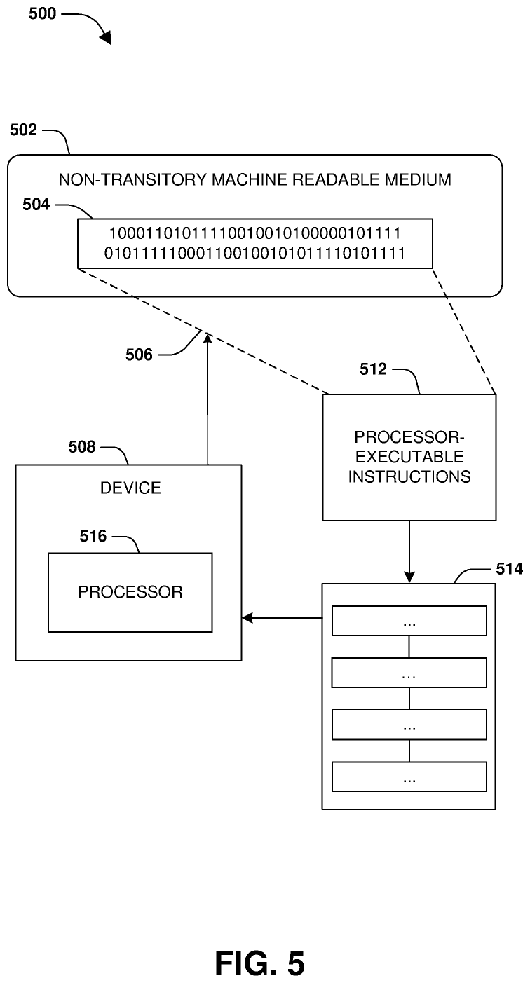

FIG. 5 is an illustration of a scenario 500 involving an example non-transitory machine readable medium 502. The non-transitory machine readable medium 502 may comprise processor-executable instructions 512 that when executed by a processor 516 cause performance (e.g., by the processor 516) of at least some of the provisions herein. The non-transitory machine readable medium 502 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 502 stores computer-readable data 504 that, when subjected to reading 506 by a device 508 (e.g., a read head of a hard disk drive, or a read operation invoked on a solid-state storage device), express the processor-executable instructions 512. In some embodiments, the processor-executable instructions 512, when executed cause performance of operations 514, such as at least some of the example method 100 of FIG. 1, for example. In some embodiments, the processor-executable instructions 512 are configured to cause implementation of a system, such as at least some of the example system 200 of FIG. 2, at least some of the example system 300 of FIG. 3, at least some of the example system 400 of FIG. 4, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

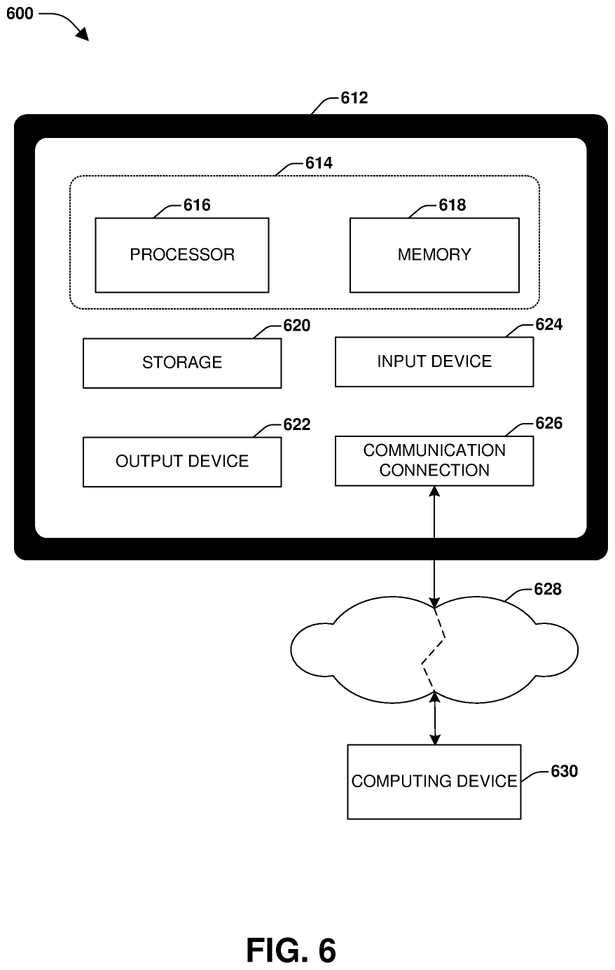

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processor 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processor 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection 626 that allows device 612 to communicate with other devices. Communication connection 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection 626 may include a wired connection or a wireless connection. Communication connection 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device 624 such as keyboard, mouse, pen, voice input device, touch input device, infrared cameras, video input devices, and/or any other input device. Output device 622 such as one or more displays, speakers, printers, and/or any other output device may also be included in device 612. Input device 624 and output device 622 may be connected to device 612 via a wired connection, wireless connection, or any combination thereof. In one embodiment, an input device or an output device from another computing device may be used as input device 624 or output device 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method involving a computing device comprising a processor, and the method comprising:
executing, on the processor, instructions that cause the processor to perform operations, the operations comprising:
evaluating incident data associated with a first road segment to determine an incident trend for the first road segment;
identifying a set of factors associated with the first road segment;
calculating a first value by combining together a first subset of the set of factors that are indicative of the first road segment being dangerous;
calculating a second value by combining together a second subset of the set of factors that are indicative of the first road segment not being dangerous;
taking the incident trend into account when calculating at least one of the first value or the second value;
generating a first danger rating for the first road segment based upon a ratio of the first value to the second value;
assigning the first danger rating to the first road; and
displaying the first danger rating on a display of the computing device.

2. The method of claim 1, the operations comprising:
modifying a visual characteristic of the first road segment displayed on a map rendered on the display of the device based upon the first danger rating.

3. The method of claim 1, the operations comprising:
evaluating the factors to identify a causation factor having a likelihood above a threshold of being a cause of incidents along the first road segment.

4. The method of claim 1, the operations comprising:
in response to determining that a second road segment lacks a threshold amount of incident data for assigning a danger rating to the second road segment, comparing factors of the second road segment to the factors of the first road segment; and
in response to the factors of the second road segment having a similarity above a threshold to the factors of the first road segment, assigning a second danger rating to the second road segment based upon the first danger rating of the first road segment.

5. The method of claim 1, the operations comprising:
in response to determining that a factor of the factors associated with the first road segment has changed as a changed factor, updating the first danger rating based upon the changed factor.

6. The method of claim 1, the operations comprising:
generating a set of routes from a starting location to a destination location for a trip to be traveled by a user;
assigning danger ratings to road segments of the set of routes, wherein the danger ratings are based upon at least one of factors of the road segments, incident data for the road segments, or driver attributes of the user; and
displaying the set of routes and the danger ratings on the display of the device.

7. The method of claim 1, the operations comprising:
generating a set of routes from a starting location to a destination location for a trip to be traveled by a user;
assigning danger ratings to road segments of the set of routes, wherein the danger ratings are based upon at least one of factors of the road segments, incident data for the road segments, or vehicle attributes of a vehicle driven by the user; and
displaying the set of routes and the danger ratings on the display of the device.

8. The method of claim 1, the operations comprising:
generating a set of routes from a starting location to a destination location for a trip to be traveled by a user;
assigning danger ratings to road segments of the set of routes; and
displaying the set of routes and a comparison of travel times versus danger ratings for the set of routes on the display of the device.

9. The method of claim 1, the operations comprising:
in response to the first danger rating exceeding a danger threshold, displaying a warning about the first road segment.

10. A computing device comprising:
a processor; and
memory comprising processor-executable instructions that when executed by the processor cause the processor to perform operations comprising:
evaluating incident data associated with a first road segment to determine an incident trend for the first road segment;
identifying factors associated with the first road segment;
identifying a set of factors associated with the first road segment;
calculating a first value by combining together a first subset of the set of factors that are indicative of the first road segment being dangerous;
calculating a second value by combining together a second subset of the set of factors that are indicative of the first road segment not being dangerous;
taking the incident trend into account when calculating at least one of the first value or the second value;
generating a first danger rating for the first road segment based upon a ratio of the first value to the second value;
assigning the first danger rating to the first road; and
displaying the first danger rating on a display of the computing device.

11. The computing device of claim 10, the operations comprising:
predicting a likelihood that an accident will occur along the first road segment during a timeframe; and
displaying the likelihood that the accident will occur on the display of the device.

12. The computing device of claim 10, the operations comprising:
performing image analysis upon imagery of the first road segment to identify a factor for inclusion with the factors associated with the first road segment.

13. The computing device of claim 10, the operations comprising:
performing image analysis upon first imagery of the first road segment to identify a first factor of the first road segment;
performing the image analysis upon second imagery of a second road segment to identify a second factor of the second road segment; and
in response to the first factor corresponding to the second factor above a threshold, assigning a second danger rating to the second road segment based upon the first danger rating of the first road segment.

14. The computing device of claim 10, the operations comprising:
evaluating autonomous vehicle data to identify a factor for inclusion with the factors associated with the first road segment.

15. The computing device of claim 10, the operations comprising:
generating a driving profile for a driver associated with the device based upon one or more trips traveled by the driver; and
utilizing the driving profile to assign danger ratings to road segments along routes of future trips to be traveled by the driver.

16. A non-transitory computer-readable storage medium having stored thereon processor-executable instructions that when executed cause a processor to perform operations comprising:
evaluating incident data associated with a first road segment to determine an incident trend for the first road segment;
identifying a set of factors associated with the first road segment;
calculating a first value by combining together a first subset of the set of factors that are indicative of the first road segment being dangerous;
calculating a second value by combining together a second subset of the set of factors that are indicative of the first road segment not being dangerous;
taking the incident trend into account when calculating at least one of the first value or the second value;
generating a first danger rating for the first road segment based upon a ratio of the first value to the second value;
assigning the first danger rating to the first road; and
displaying the first danger rating on a display of the computing device.

17. The non-transitory computer-readable storage medium of claim 16, the operations comprising:
generating a set of routes from a starting location to a destination location for a trip to be traveled by a user;
assigning danger ratings to road segments of the set of routes, wherein the danger ratings are based upon at least one of demographic information of the user or demographic information of residents within a proximity distance threshold of the road segments; and
displaying the set of routes and the danger ratings on the display of the device.

18. The non-transitory computer-readable storage medium of claim 16, the operations comprising:
assigning danger ratings to road segments of a set of routes as road safety data; and
reducing the road safety data to a reduced set of road safety data corresponding to percentages of road segments along the set of routes that correspond to values of danger ratings.

19. The non-transitory computer-readable storage medium of claim 16, the operations comprising:
identifying trends of drivers across demographic profiles as trend data;
pre-populating a driving profile for a driver based upon a portion of the trend data corresponding to demographic profile information of the driver; and
utilizing the driving profile to assign danger ratings to road segments along routes of future trips to be traveled by the driver.

20. The non-transitory computer-readable storage medium of claim 16, the operations comprising:
evaluating information corresponding to a planned road segment to be built to assign a danger rating for the planned road segment.
